(19) United States
(12) Patent Application Publication
(10) Pub. No.: US 2015/0235331 A1
(43) Pub. Date: Aug. 20, 2015

(54) METHOD AND APPARATUS FOR EVALUATING PROPERTIES

(71) Applicant: ReZamp, Chandler, AZ (US)

(72) Inventors: Brandon Michael Hunt, Chandler, AZ (US); Justin James Schnettler, Chandler, AZ (US); Brad James Berdine, Gilbert, AZ (US)

(21) Appl. No.: 14/182,807

(22) Filed: Feb. 18, 2014

(51) Int. Cl. G06Q 50/16; G06Q 30/00

(52) U.S. Cl. CPC G06Q 50/16; G06Q 30/00

(57) ABSTRACT

A method and system for evaluating properties, comprises receiving, using a computing device, data describing a plurality of characteristics for each of a plurality of properties, identifying, using the computing device, subject properties by applying search criteria to the data, the subject properties satisfying the search criteria, for a selected subject property, identifying, using the computing device, comparable properties by applying configuration criteria to the data, the comparable properties satisfying the configuration criteria, and determining, using the computing device, an Rvalue of the selected subject property by averaging normalized prices of a plurality of comparable properties, the Rvalue indicating an after-repair value of the selected subject property.

### FIELD

The present disclosure is generally related to methods and apparatuses for evaluating properties, and more particularly to methods and apparatuses for providing an indication of the resale value of properties based on normalized values of comparable properties having a particular level of relevance to a currently available subject property.

### BACKGROUND

In the property or real estate investment industry, one goal is to identify properties that may be re-sold for a profit (after repairs or otherwise) or that are likely otherwise undervalued when listed, thereby presenting an immediate value increase to the purchaser. In any particular real estate market, however, hundreds or thousands, and even tens of thousands of properties may be listed for sale, and the data related to those listings (e.g., price) may change frequently. Accordingly, the amount of data for any investor or purchaser to evaluate when attempting to identify properties that are likely to provide a desired return-on-investment (“ROI”) is vast, constantly changing, and difficult to analyze even if the dynamic nature of the data was not a factor.

In addition to the large number of listings in a selected market of potentially desirable properties, investors and/or purchasers (and their advisors) must, in order to identify high ROI properties, evaluate comparable properties by considering their location, features, listing and selling prices, and listing history. As is well known in the industry, the best indicator of the true value of a subject property is the value obtained (or at a minimum sought) for properties that are located nearby and share very similar features with the subject property. Efficiently and accurately identifying such comparable properties, and relating their value to the potential value of a subject property, is essentially impossible using conventional techniques.

As such, it is desirable to provide an efficient, automated system for identifying properties that match a potential purchaser's criteria, identifying comparable properties for properties selected by the user from the set of properties that satisfy the criteria, and providing an indication of the value of the subject properties based on the values of the comparable properties and the degree to which the comparable properties are similar to the subject properties.

### SUMMARY

In one embodiment of the present disclosure, a method for evaluating properties is provided that comprises receiving, using a computing device, data describing a plurality of characteristics for each of a plurality of properties, identifying, using the computing device, subject properties by applying search criteria to the data, the subject properties satisfying the search criteria, for a selected subject property, identifying, using the computing device, comparable properties by applying configuration criteria to the data, the comparable properties satisfying the configuration criteria, and determining, using the computing device, an Rvalue of the selected subject property by averaging normalized prices of a plurality of comparable properties, the Rvalue indicating an after-repair value of the selected subject property. In one aspect of this embodiment, receiving includes receiving MLS data from an MLS system over a network. In another aspect, the method further includes receiving the search criteria from a user system connected to the computing device over a network. In a variant of this aspect, the search criteria permit a user to specify geographic, physical and financial parameters required for a subject property to be identified from the plurality of properties. In another aspect of this embodiment, identifying comparable properties includes applying a plurality of configuration criteria to the data, application of a first of the plurality of configuration criteria resulting in identification of comparable properties having a first degree of relevance to the selected subject property, and application of a second of the plurality of configuration criteria resulting in identification of comparable properties having a second degree of relevance to the selected subject property, the first degree of relevance being greater than the second degree of relevance. In a variant of this aspect, each of the plurality of configuration criteria specify geographic, physical and financial parameters required for a comparable property to be identified as a comparable property having a degree of relevance to the selected subject property associated with the configuration criteria. In yet another aspect of this embodiment, the normalized prices of the plurality of comparable properties include adjustments from sales prices based on features of the plurality of comparable properties as specified in the configuration criteria. In another aspect, the configuration criteria specifies a number of comparable properties to be used in determining the Rvalue. In yet another aspect, the method further includes determining, using the computing device, a Uvalue by averaging the normalized prices of the plurality of comparable properties. A variant of this aspect further includes enabling a user to select comparable properties satisfying the configuration criteria other than the plurality of comparable properties, and determining a new Uvalue by averaging normalized prices of the selected comparable properties.

In another embodiment according to the present disclosure, a non-transitory computer-readable media is provided including instructions that, when executed by a processor, cause the processor to access data stored in a database associated with the processor, the data describing a plurality of characteristics for each of a plurality of properties, identify subject properties by applying search criteria to the data, the subject properties satisfying the search criteria, for a subject property selected by a user with an input device, identify comparable properties by applying configuration criteria to the data, the comparable properties satisfying the configuration criteria, and determine an Rvalue of the selected subject property by averaging normalized prices of a plurality of comparable properties, the Rvalue indicating an after-repair value of the selected subject property. In one aspect of this embodiment, the instructions, when executed by the processor, further cause the processor to receive the search criteria from a user system connected to the processor over a network. In a variant of this aspect, the search criteria permit a user to specify geographic, physical and financial parameters required for a subject property to be identified from the plurality of properties. In another aspect of this embodiment, the instructions, when executed by the processor, further cause the processor to identify comparable properties by applying a plurality of configuration criteria to the data, application of a first of the plurality of configuration criteria resulting in identification of comparable properties having a first degree of relevance to the selected subject property, and application of a second of the plurality of configuration criteria resulting in identification of comparable properties having a second degree of relevance to the selected subject property, the first degree of relevance being greater than the second degree of relevance. In a variant of this aspect, each of the plurality of configuration criteria specify geographic, physical and financial parameters required for a comparable property to be identified as a comparable property having a degree of relevance to the selected subject property associated with the configuration criteria. In still another aspect of this embodiment, the normalized prices of the plurality of comparable properties include adjustments from sales prices based on features of the plurality of comparable properties as specified in the configuration criteria. In another aspect, the configuration criteria specifies a number of comparable properties to be used in determining the Rvalue. In yet another aspect, the instructions, when executed by the processor, further cause the processor to determine a Uvalue by averaging the normalized prices of the plurality of comparable properties. In a variant of this aspect, the instructions, when executed by the processor, further cause the processor to enable a user to select comparable properties satisfying the configuration criteria other than the plurality of comparable properties, and determine a new Uvalue by averaging normalized prices of the selected comparable properties.

In yet another embodiment according to the present disclosure, a system for evaluating properties is provided, comprising a network interface configured to couple to a first computing device and a second computing device over a network, a computing device having a processor and a memory including instructions for execution by the processor, and a database, wherein the instructions, when executed by the processor, cause the processor to receive data describing a plurality of properties from the first computing device over the network, store the received data in the database, identify subject properties by applying search criteria to the received data, the subject properties satisfying the search criteria, receive a selection of a subject property from the second computing device over the network, for the selected subject property, identify comparable properties by applying configuration criteria to the received data, the comparable properties satisfying the configuration criteria, and determine an Rvalue of the selected subject property by averaging normalized prices of a plurality of comparable properties, the Rvalue indicating an after-repair value of the selected subject property.

### BRIEF DESCRIPTION OF THE DRAWINGS

The foregoing aspects and many of the attendant advantages of this disclosure will become more readily appreciated and the same will become better understood by reference to the following detailed description when taken in conjunction with the accompanying drawings.

FIG. 1 is a block diagram of an exemplary application of an analysis system according to one embodiment of the present disclosure.

FIG. 2 is a block diagram of an analysis system according to one embodiment of the present disclosure.

FIG. 3 is a block diagram of an MLS system for use with the analysis system of FIG. 2.

FIG. 4 is a block diagram of a client system for use with an analysis system of FIG. 2.

FIG. 5 is a search screen generated by an analysis system according to one embodiment of the present disclosure.

FIG. 6 is an add search screen generated by an analysis system according to one embodiment of the present disclosure.

FIG. 7 is a results screen generated by an analysis system according to one embodiment of the present disclosure.

FIGS. 8A and 8B are enlarged views of a results grid portion of the results screen of FIG. 7.

FIG. 9 is an enlarged view of a comp listing portion of the results screen of FIG. 7.

FIG. 10 is a property detail screen generated by an analysis system according to one embodiment of the present disclosure.

FIG. 11 is an adjustments viewer screen generated by an analysis system according to one embodiment of the present disclosure.

FIGS. 12 and 13 are enlarged views of a map display portion of the results screen of FIG. 7.

FIG. 14 is a configuration screen generated by an analysis system according to one embodiment of the present disclosure.

FIG. 15 is a conceptual view of mapping of an XML feed to a standardized schema.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates embodiments of the invention, and such exemplifications are not to be construed as limiting the scope of the invention in any manner.

### DETAILED DESCRIPTION OF EMBODIMENTS OF THE DISCLOSURE

For the purposes of promoting an understanding of the principles of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrated devices and described methods and further applications of the principles of the disclosure which would normally occur to one skilled in the art to which the disclosure relates.

The detailed descriptions which follow are presented in part in terms of algorithms and symbolic representations of operations on data bits within a computer memory representing alphanumeric characters or other information. These descriptions and representations are the means used by those skilled in the art of data processing to most effectively convey the substance of their work to others skilled in the art.

An algorithm is here, and generally, conceived to be a sequence of steps leading to a desired result. These steps are those requiring physical manipulations of physical quantities. Usually, though not necessarily, these quantities take the form of non-transient electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory. Rather, they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. That is not the case for any of the operations described herein which form part of the present disclosure; the operations are machine operations. Useful machines for performing the operations of the present disclosure include general purpose digital computers or other similar devices. In all cases the distinction between the method operations in operating a computer and the method of computation itself should be recognized. The present disclosure includes methods and apparatuses for operating a computer in processing electrical or other non-transient physical signals to generate other desired, non-transient physical signals.

The present disclosure also relates to a system of devices for performing these operations. These devices may be specifically constructed for the required purposes or may comprise a general purpose computer as selectively activated or reconfigured by a computer program executed by the computer. The algorithms presented herein are not inherently related to any particular computer or other apparatus. In particular, various general purpose machines may be used with programs written in accordance with the teachings herein, or it may prove more convenient to construct more specialized computing devices to perform the required method steps. The required structure for a variety of these machines will appear from the description below.

Both the programs and databases disclosed herein may be objects in an object-oriented system. The actual physical implementation of a database on a general purpose computer may take several forms, from complete individual records storing the substantive information with several key indexes for locating a particular record, to a plurality of tables interrelated by relational operations, to a matrix of cross-linked data records, to various combinations and hybrids of these general types. In particular physical devices, a database may be structured and arranged to accommodate the restrictions of the physical device—but when transferred to a general purpose computer be able to be stored in a variety of formats. Thus, while certain types of information may be described as being stored in a “database” from a conceptual standpoint, generally such information may be electronically stored in a variety of structures with a variety of encoding techniques.

Databases may contain many types of information, and may store the information in a variety of encoding techniques. When a database stores information that relates to a particular person, condition, location, or other thing, the database typically uses a unique identifier that binds the “concept” of the person, condition, location, or other thing with a storable piece of data. When the unique identifier is used to reference the data record, the unique identifier may be termed a “key” and data records associated with the “concept” are said to be “keyed” by the unique identifier. The association between a key and its data may be implemented in a variety of ways, for example by having the key be a field in a corresponding data record, by having a key value in a search tree with an associated pointer to one or more data records corresponding to the key, or by encoding the corresponding information with a value that upon decoding produces the unique identifier and the corresponding data, etc. By these various methods, instances of data may be associated with, or “bound” with or to, the “concept” by using the key.

The terms “network,” “local area network,” “LAN,” “wide area network,” or “WAN” mean two or more computing devices which are connected in such a manner that information may be transmitted between the computing devices. In such computer networks, typically one or more computing devices operate as a “server,” a computer with large storage devices such as hard disk drives and communication hardware to operate peripheral devices such as printers or modems. Other computing devices, sometimes called “workstations,” provide a user interface so that users of computer networks can access the network resources, such as shared data files, common peripheral devices, and inter-workstation communication. The computing devices have at least one processor for executing machine instructions, and memory for storing instructions and other information. Many combinations of processing circuitry and information storing equipment are known by those of ordinary skill in these arts. A processor may be a microprocessor, a digital signal processor (“DSP”), a central processing unit (“CPU”), or other circuit or equivalent capable of interpreting instructions and/or performing logical actions on information. Memory includes both volatile and non-volatile memory, including temporary and cache, in electronic, magnetic, optical, or other format used to store information. Users activate computer programs or network resources to create “processes” which include both the general operation of the computer program along with specific operating characteristics determined by input variables and its environment.

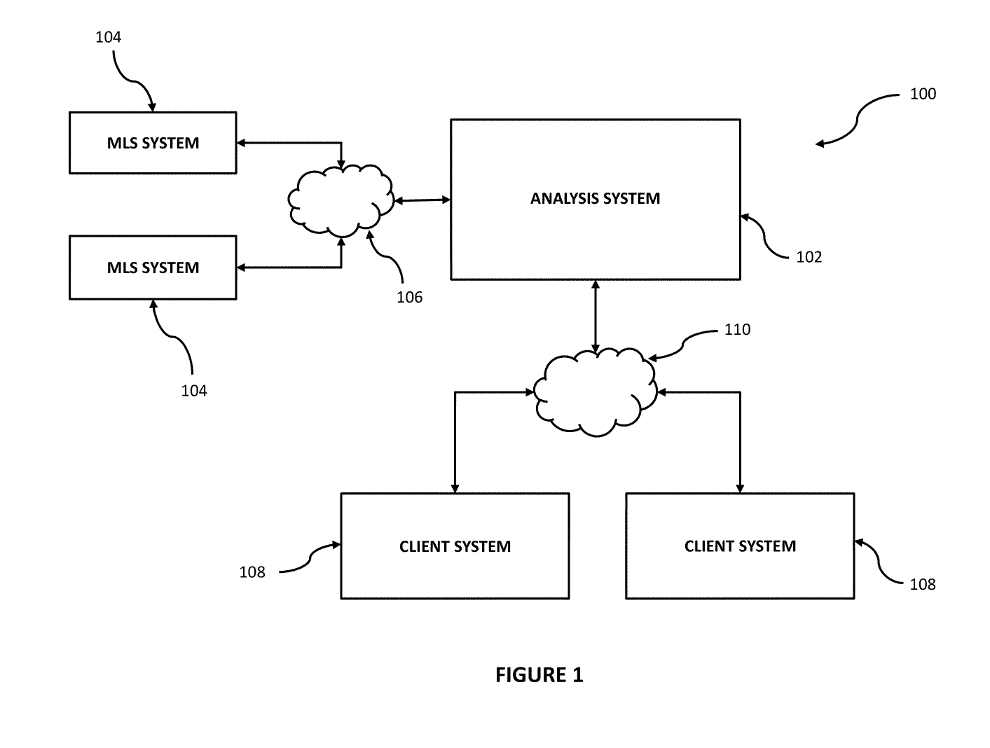

Referring now to FIG. 1, an evaluation system according to one embodiment of the present disclosure is shown. Evaluation system 100 generally includes an analysis system 102, one or more MLS systems 104 (only two shown) in communication with analysis system 102 via a network 106, and one or more client systems 108 (only two shown) in communication with analysis system 102 via a network 110. As will be understood by those skilled in the art, at least portions of networks 106, 110 may be the same network. In general, and as will be described in greater detail below, analysis system 102 communicates with MLS system(s) 104 to acquire property data, analyzes that data based on client criteria and configuration information, and communicates with client system(s) 108 to provide analysis results.

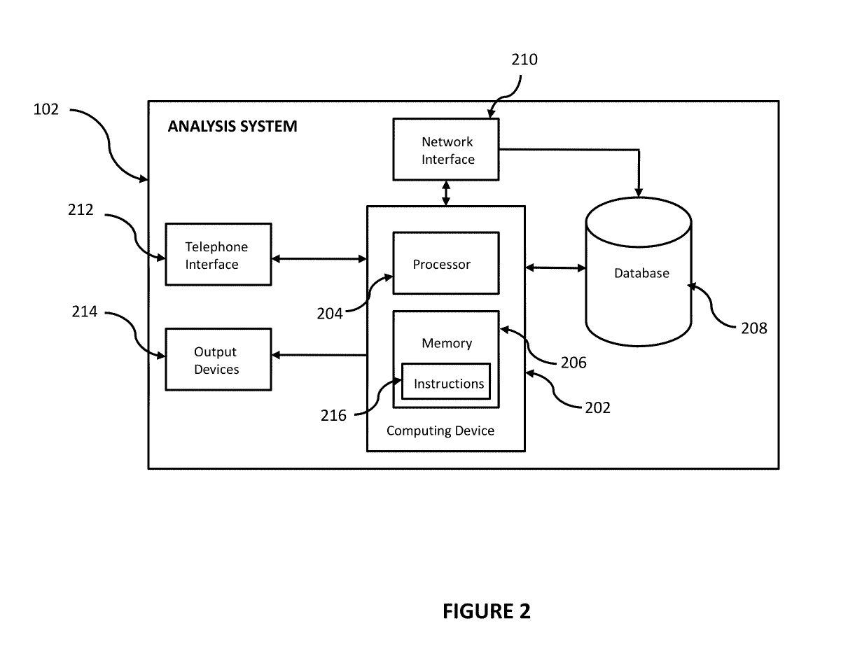

Analysis system 102 is depicted in further detail in FIG. 2. In an exemplary embodiment, analysis system 102 generally includes a computing device 202 having a processor 204 and a memory 206, a database 208, a network interface 210, a telephone interface 212, and one or more output devices 214. Additionally, memory 206 of analysis system 102 includes a plurality of machine-readable instructions 216 which form structural elements of memory 206 and which, when executed by processor 204 cause computing device 202 to perform the plurality of functions described herein.

While analysis system 102 is depicted as a singular entity, it will be understood by those skilled in the art that analysis system 102 may be implemented as multiple entities, in a distributed network or other suitable fashion wherein the various structural and functional characteristics of analysis system 102 are performed in different locations and/or by different devices. Similarly, it should be understood that computing device 202 of analysis system 102 may be implemented using multiple computing devices, such as multiple personal computing devices, multiple workstations, and/or multiple servers, and that each computing device 202 may include more than one processor 204 and/or more than one memory 206. Likewise, while database 208 is referred to herein as a central database functioning as a repository for a variety of different data items and data structures, database 208 may be implemented as a distributed database wherein certain database items are stored in one location and other database items are stored in one or more other locations. Additionally, or in the alternative, database items may be stored redundantly in two or more databases 208. Also, analysis system 102 may include a plurality of network interfaces 210 and/or a plurality of telephone interfaces 212. In accordance with the foregoing, the connecting lines in FIG. 2 between the various components of analysis system 102 are intended to depict any suitable operational connection, including, but not limited to, direct and indirect wired connections and wireless connections either within a closed system or over one or more networks.

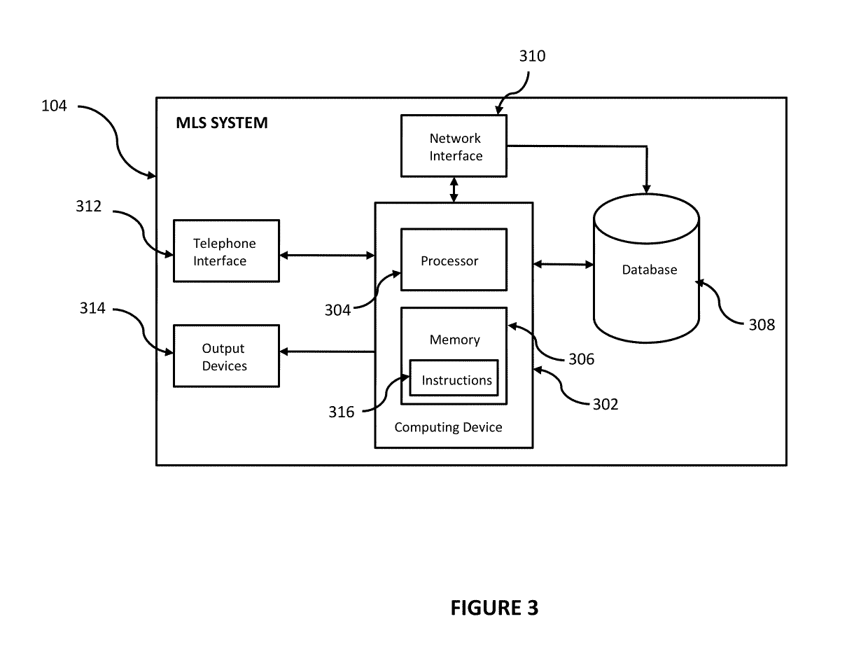

Referring now to FIG. 3, in an exemplary embodiment, MLS system 104 generally includes a computing device 302 having a processor 304 and a memory 306, a database 308, a network interface 310, a telephone interface 312 and one or more output devices 314. Additionally, memory 306 of MLS system 104 includes a plurality of machine-readable instructions 316 which form structural elements of memory 306 and which, when executed by processor 304 cause computing device 302 to perform the plurality of functions described herein.

While MLS system 104 is depicted as a singular entity, it will be understood by those skilled in the art that MLS system 104 may be implemented as multiple entities, in a distributed network or other suitable fashion wherein the various structural and functional characteristics of MLS system 104 are performed in different locations and/or by different devices. Similarly, it should be understood that computing device 302 of MLS system 104 may be implemented using multiple computing devices, such as multiple personal computing devices, multiple workstations, and/or multiple servers, and that each computing device 302 may include more than one processor 304 and/or more than one memory 306. Likewise, MLS system 104 may include a plurality of network interfaces 310 and/or a plurality of telephone interfaces 312. In accordance with the foregoing, the connecting lines in FIG. 3 between the various components of MLS system 104 are intended to depict any suitable operational connection, including, but not limited to, direct and indirect wired connections and wireless connections either within a closed system or over one or more networks.

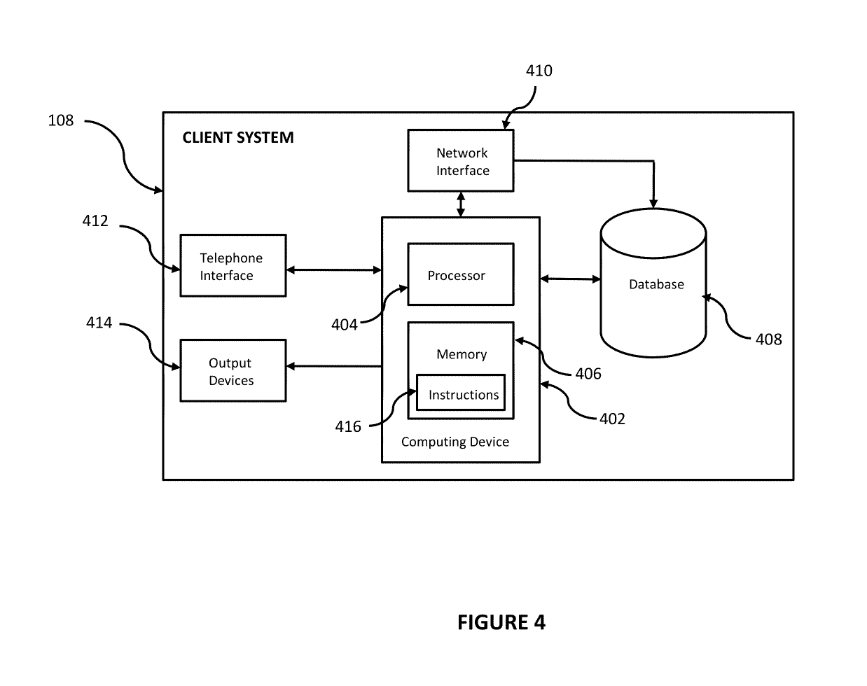

FIG. 4 depicts an exemplary embodiment of a client system 108. Client system 108 generally includes a computing device 402 having a processor 404 and a memory 406, a database 408, a network interface 410, a telephone interface 412 and one or more output devices 414. Additionally, memory 406 of client system 108 includes a plurality of machine-readable instructions 416 which form structural elements of memory 406 and which, when executed by processor 404 cause computing device 402 to perform the plurality of functions described herein.

While client system 108 is depicted as a singular entity, it will be understood by those skilled in the art that client system 108 may be implemented as multiple entities, in a distributed network or other suitable fashion wherein the various structural and functional characteristics of client system 108 are performed in different locations and/or by different devices. Similarly, it should be understood that computing device 402 of client system 108 may be implemented using multiple computing devices, such as multiple personal computing devices, multiple workstations, and/or multiple servers, and that each computing device 402 may include more than one processor 404 and/or more than one memory 406. Likewise, client system 108 may include a plurality of network interfaces 410 and/or a plurality of telephone interfaces 412. In accordance with the foregoing, the connecting lines in FIG. 4 between the various components of client system 108 are intended to depict any suitable operational connection, including, but not limited to, direct and indirect wired connections and wireless connections either within a closed system or over one or more networks.

Each of analysis system 102, MLS system 104 and client system 108 may carry out the specified functions described herein in a manner consistent with the operation of a conventional computing system programmed with instructions for performing the specified functions. For example, client system 108 may communicate with analysis system 102 by processor 404 executing instructions 416 in memory 406 to launch an instance of a browser program such that network interface 410 may connects through network 110 to analysis system 102. Thereafter, analysis system 102 may generate screens (such as those described below) on output device 414 (i.e., a display) of client system 108 by processor 204 executing instructions 216 in memory 206 and accessing property data stored in database 208. As explained below, analysis system 102 may further communicate with (e.g., provide notifications to) either client system 108 or other communication devices of a user (e.g., mobile phone, tablet computing device, etc.) through telephone interface 212.

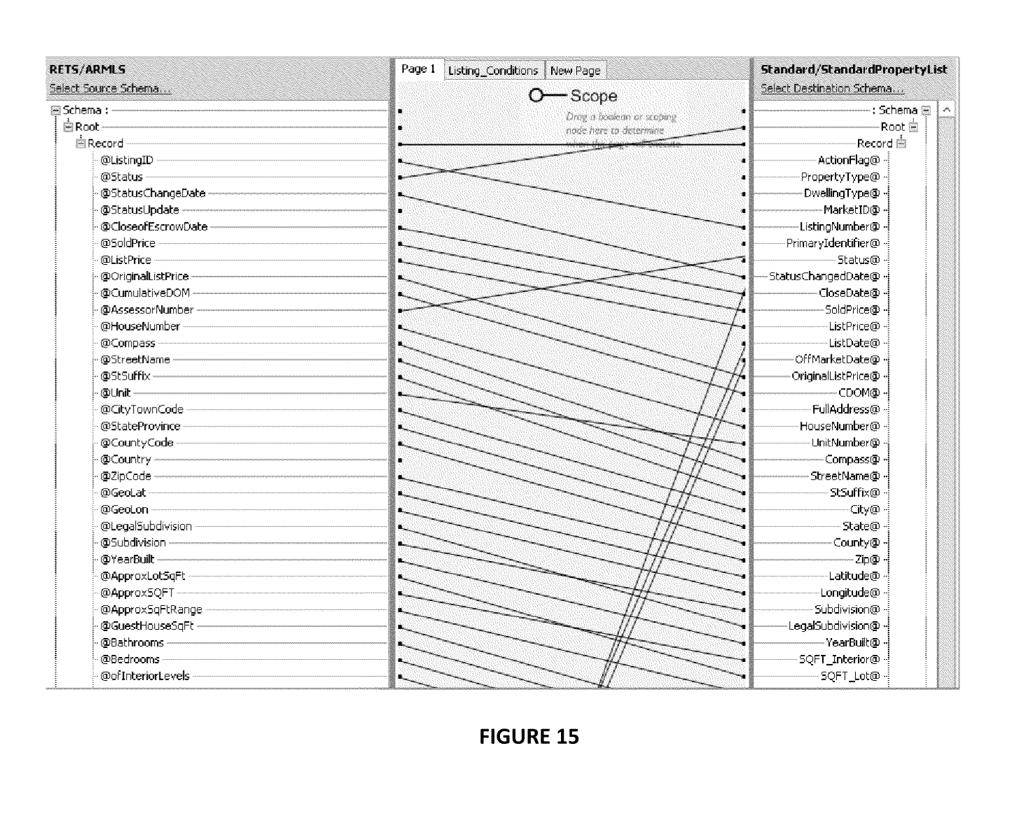

Referring back to FIG. 1, MLS systems 104, which are operated by various boards of realtors across the country, include in databases 308 (FIG. 3) vast numbers of files including property data used by analysis system 102. To process the data, analysis system 102 first pre-processes the files to standardize the data. More specifically, MLS systems 104 provide feeds of files via network 106 that are inputs for creation of flat files such as by using Rets Connector, distributed by ProLogic. Next, the flat files are converted into XML using a schema designed for each unique feed (i.e., each feed from each MLS system 104). Then, using XML or an alternative mode of manipulation, each XML feed is mapped to a standardized schema. An example of such mapping is depicted as FIG. 15. With the file in standardized form, standard operations that are common to all XML files are performed, such as standardization of property status information (i.e., closed, sold, etc.). Finally, the standardized XML file is output for importation into database 208.

For importation of standardized XML files, processor 204 first reads the files into memory 206. Processor 204 further reads the name of the market, which essentially identifies the source MLS system 104 from the name of the file. Processor 204 then uses the name of the market to pull a database mapping file from database 208 that will be used to store the standardized XML file data in database 208. For each record in the standardized XML file, a stored procedure is called with all of the necessary parameters using the database mapping file. The stored procedure also determines whether to insert a new record in database 208 for a particular property or to update an existing record.

In one embodiment of the disclosure, a user of client system 108, which may be a real estate agent looking for properties to show to clients or individual real estate investors, operates client system 108 using one or more input devices (e.g., a keyboard and/or a mouse) not shown) to establish a connection with analysis system 102 via network 110. As indicated above, to establish this connection, the user may launch a browser (or similar software component stored as instructions 416 in memory 406 of computing device 402), identify analysis system 102 as a destination web address, and thereby access a web site operated by analysis system 102 via network interface 410, network 110 (i.e., the internet), and network interface 210 in a conventional fashion. Upon establishing a communication link with analysis system 102, the user may be required to log in to analysis system 102 by providing log in credentials (e.g., a username and password) according to principles that are well known in the art.

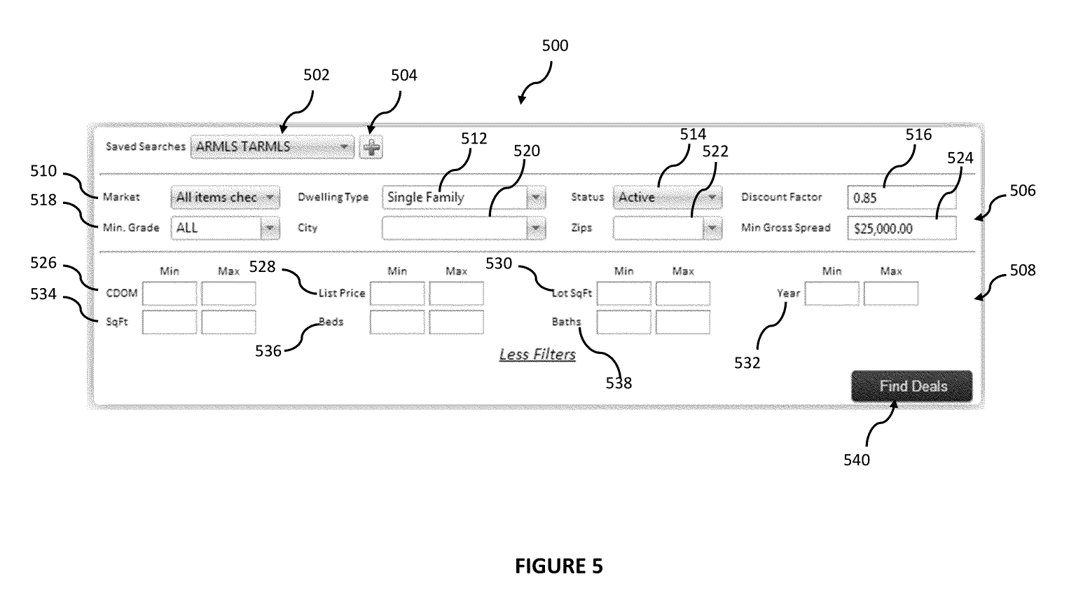

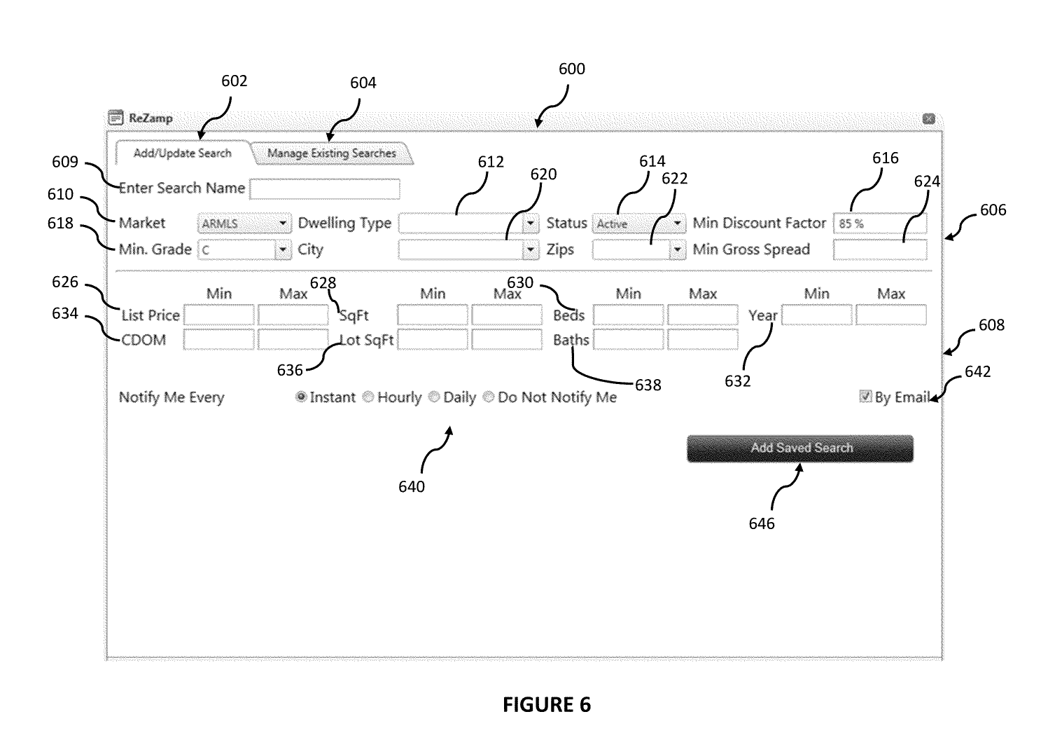

Upon logging in to analysis system 102, the user is presented with a search screen such as that depicted in FIG. 5. In general, search screen 500 may be used to establish search criteria for use by analysis system 102 in identifying properties of interest to the user. Search screen 500 generally includes a saved search selection drop-down 502, an add new search icon 504, a market criteria area 506 and a property criteria area 508. Drop-down 502 permits the user to select from prior saved searches to use and/or edit the search criteria of the selected search. Add new search icon 504 permits the user to name a new search and populate the various fields of search screen 500 for that new search as described below with reference to FIG. 6. When a user selects a saved search using saved search selection drop-down 502 any defined criteria associated with that search is automatically populated in the various fields depicted in search screen 500.

Regarding those various fields, market criteria area 506 includes a market field 510, a dwelling type field 512, a status field 514, a discount factor field 516, a min. grade field 518, a city field 520, a zip code field 522 and a min. gross spread field 524. Market field 510 permits the user to select from various geographically limited MLS listing areas, which will establish the subset of property data in database 208 to be searched. For example, the market may correspond to a geography (e.g., a state) served by a broker or brokerage firm that is associated with operators of analysis system 102. Dwelling type field 512 permits the user to select from various different types of properties such as single family dwellings, duplexes, townhomes, apartments, etc. Status field 514 permits the user to specify the status of properties that should be returned as results from a search. For example, the user may select only active properties, which limits the search results to properties that are currently on the market, only pending properties, which limits the results to properties that are under contract but not yet closed, only closed properties, etc. The discount factor field 516 permits the user to specify the minimum desired discount percentage of a property. For example, a discount factor of 85% in discount factor field 516 will yield a search result including properties priced at 85% or less of the property's after repair value (ARV). The min. grade field permits the user to select the minimum grade for comparable properties to be provided with subject properties that meet the search criteria. Throughout this disclosure, comparable properties may be referred to as “comps.” The grade levels may be A though F, and correspond to an indication of the similarity of the comparable properties to a subject property as is further described below. In the example of FIG. 5, all grades of comparable properties will be returned with the search results. The city field permits the user to specify the city to which the search should be limited. Similarly, the zip code field 522 permits the user to limit the search to a particular zip code. Finally, the min. gross spread field 524 permits the user to specify the minimum desired difference between the list price of a subject property and the potential value (after repairs) of the property-later described as the Rvalue.

The property criteria area 508 of search screen 500 includes CDOM (cumulative days on the market) fields 526 (min. and max.), list price fields 528 (min. and max.), lot square footage fields 530 (min. and max.), year fields 532 fields (min. and max.), structure square footage fields 534 (min. and max.), beds fields 536 (min. and max.), and baths fields 538 (min. and max.). CDOM fields 526 permit the user to specify the minimum and/or maximum number of days the returned subject properties have been on the market. List price fields 528 permit the user to specify the minimum and/or maximum list price of the subject properties to be returned with the search results. Lot square footage fields 530 permit the user to specify the minimum and/or maximum acceptable lot sizes. Year fields 532 permit the user to specify the minimum and/or maximum build dates for properties to be returned with the search results. Similarly, structure square footage fields 534, beds fields 536, and baths fields 538 permit the user to specify the minimum and/or maximum acceptable structure square footage, number of bed rooms, and number of bathrooms, respectively, for subject properties to be returned with the search results.

After the user is satisfied with the automatically populated criteria data associated with the selected saved search, or after the user edits that data, the user may cause analysis system 102 to perform a search for subject properties that satisfy the specified criteria by actuating find deals button 540. This causes processor 204 of computing device 202 to execute instructions 216 associated with performing a property search, which include accessing database 208 and evaluating property listings stored therein to identify properties that satisfy the search criteria specified on search screen 500.

As indicated above, a user may add and/or edit saved searches by actuating add new search icon 504 of search screen 500. Upon actuating icon 504, analysis system 102 generates an add search screen such as screen 600 depicted in FIG. 6. Add search screen 600 generally includes an add tab 602, a manage searches tab 604, a market criteria area 606, and a property criteria area 608. When add tab 602 is active (as shown in FIG. 6), the user is provided a name field 609 for naming the search to be saved. All of the fields in market criteria area 606 are the same as the fields in market criteria area 506 described above with reference to FIG. 5. Similarly, all of the fields in property criteria area 608 are the same as the fields in property criteria area 508 described above with reference to FIG. 5. When manage searches tab 604 is active (not shown), the user is presented with a listing of all saved search associated with the user, along with the options of making a particular search the default search, deleting searches, and editing searches.

Add search screen 600 also includes a plurality of notification radio buttons 640 which allow the user to specify how frequently (if at all) analysis system 102 should provide notice to the user of the availability of results from the saved search. By checking email box 642, the user can specify that such notices be provided via email to the user's email address, which may be provided when the user sets up an account with analysis system 102. It should be understood that any of a variety of acceptable notification methods may be implemented (in addition to or instead of email), such as text notification or phone notification. A user's saved search criteria is populated with new results immediately when new results are available, as long as the user is logged in to analysis system 102. The notification function described above will also syndicate (i.e., text, email, etc.) search results based on the frequency selection associated with a user's saved search criteria.

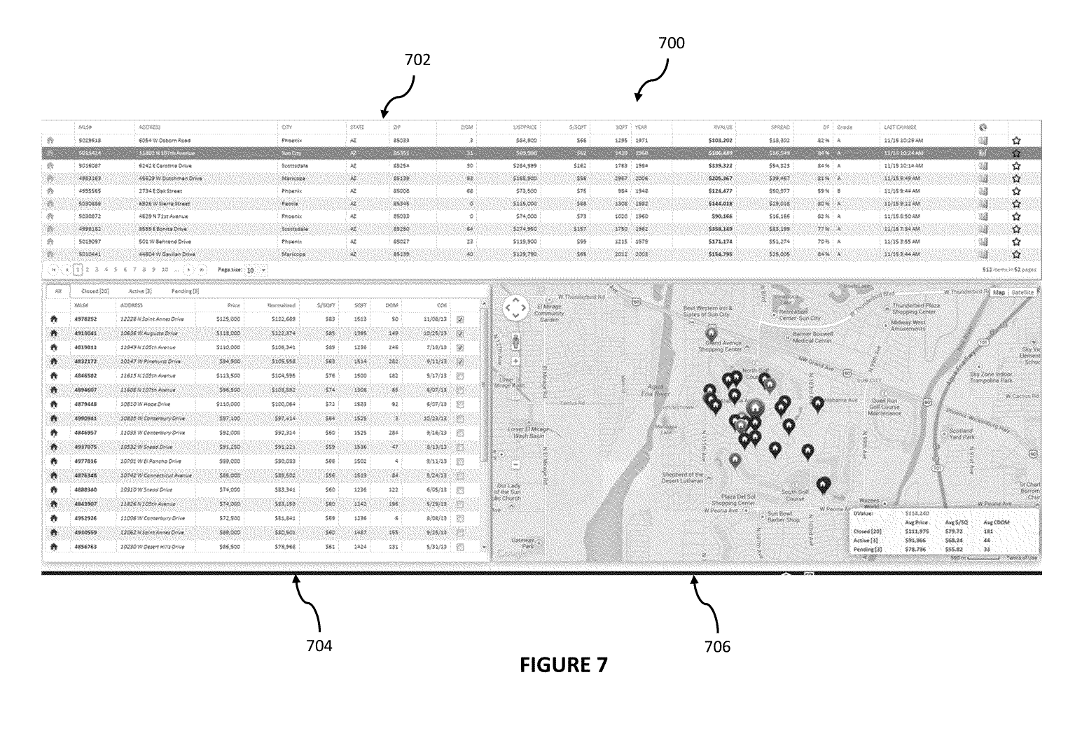

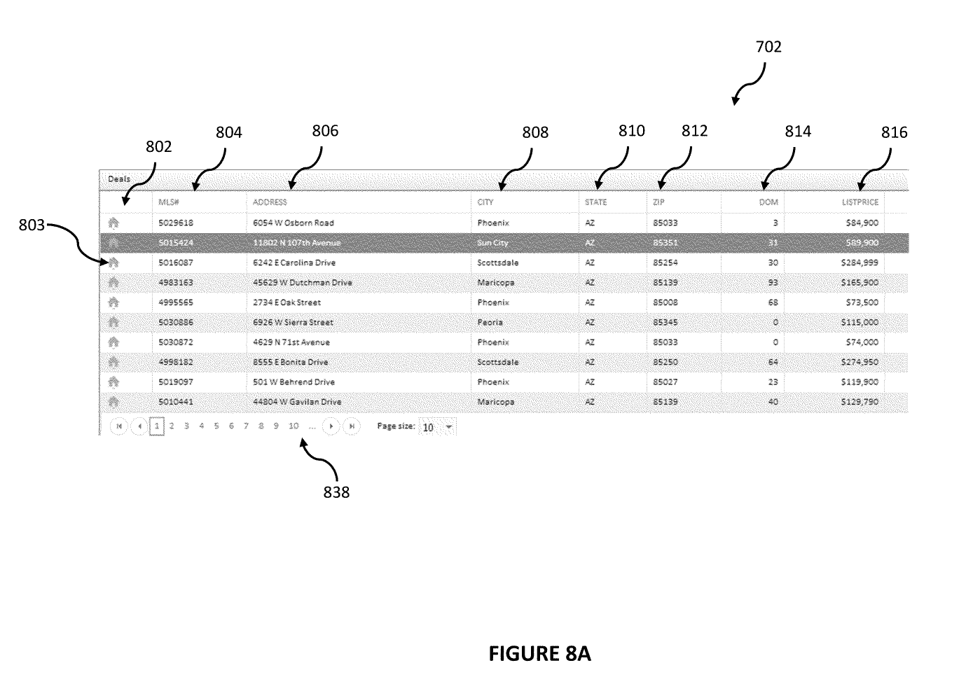

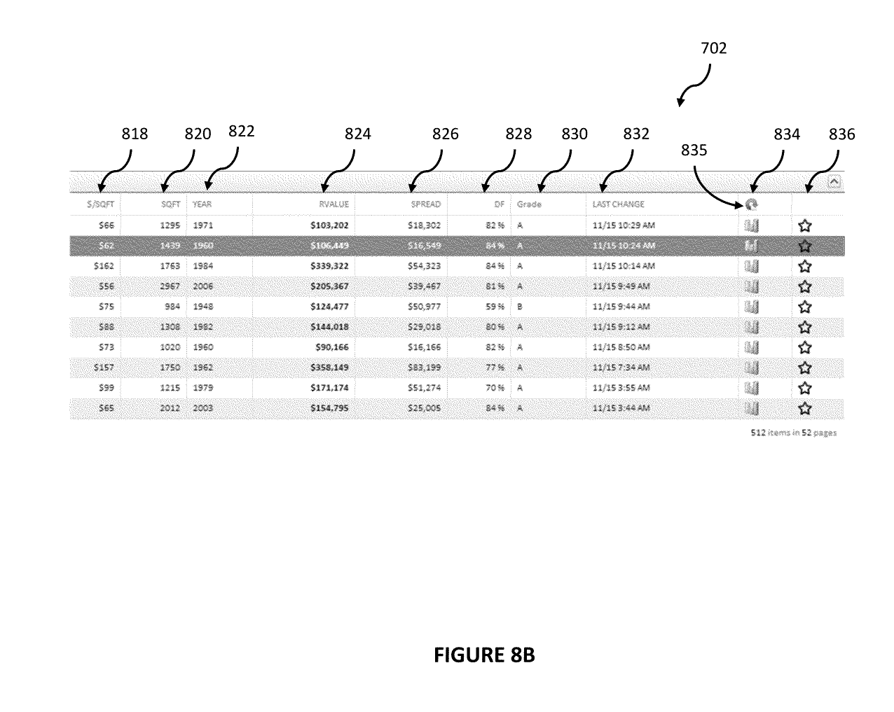

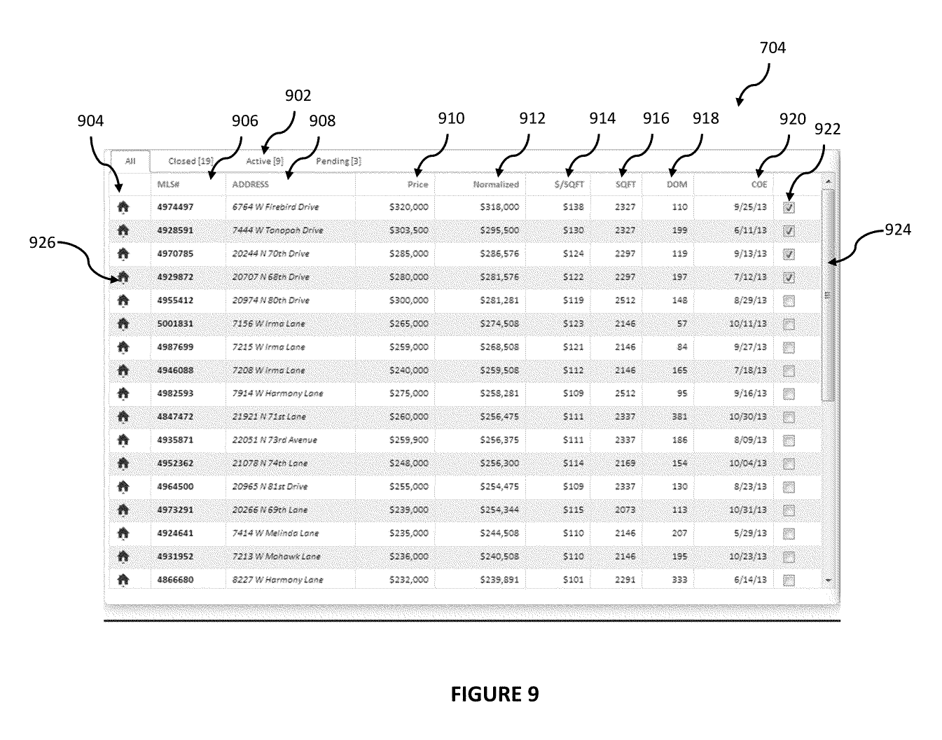

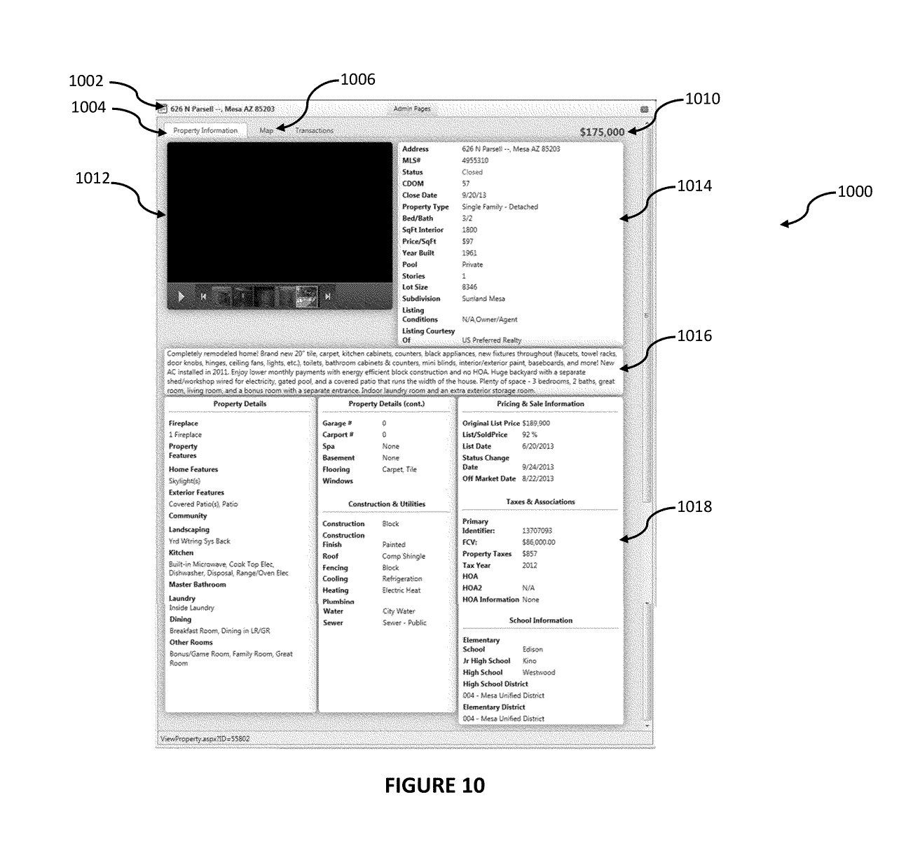

In response to performing a search in the manner described above, analysis system 102 may generate a results screen 700 such as that depicted in FIG. 7. Results screen 700 generally includes a results grid 702 and a comp viewer area including a comp listing 704 and map display 706. FIGS. 8A and 8B show results grid 702 in greater detail. Similarly, FIGS. 9 and 10 show enlarged views of comp listing 704 and map display 706, respectively. In one embodiment of the disclosure, only results grid 702 is initially displayed on results screen 700. When a user activates a particular subject property (such as the property highlighted in results grid 702 of FIG. 7), analysis system 102 populates comp listing 704 and map display 706 with information about comparable properties for the selected subject property.

Referring now to FIGS. 8A and 8B, results grid 702 displays information relating to properties that satisfy a particular set of search criteria (i.e., a saved search) in a tabular format. The columns include a property detail column 802, an MLS# column 804, an address column 806, a city column 808, a state column 810, a zip code column 812, a DOM (days on the market) column 814, a list price column 816, a price/square foot column 818, a square foot column 820, a year column 822, an Rvalue column 824, a spread column 826, a DF column 828, a grade column 830, a last change column 832, a collapse grid column 834 and a favorites column 836. Finally, results grid 702 includes display control icons 838 which permit the user to specify the number of subject properties resulting from the search to be listed in results grid 702 and to navigate through pages of listed subject properties.

Property detail column 802 includes a property icon 803 associated with each listed property. Actuation of a property icon 803 causes analysis system 102 to display a property detail screen (such as that described with reference to FIG. 10 below) that provides detailed information about the subject property associated with the icon 803. MLS# column 804 indicates the MLS listing number associated with the property. Similarly, address column 806, city column 808, state column 810 and zip code column 812 provide further geographic information about the subject property. DOM column 814 indicates the number of days the subject property has been on the market. List price column 816 indicates the current asking price for the subject property. Price/square foot column 818 provides the result of the list price of the subject property divided by the property's square footage, which is listed in square footage column 822. Rvalue column 824 provides the Rvalue computed by analysis system 102 for the identified property as is described in greater detail below. Spread column 826 indicates the difference between the list price and the Rvalue for the subject property. DF column 828 displays the discount factor associated with the identified property, which is the property list price (column 816) divided by the property Rvalue (column 824). Grade column 830 indicates the grade computed by analysis system 102 to be associated with the corresponding Rvalue as described in greater detail below. Last change column 832 indicates the date on which the status of the identified property last changed. A status change could include, for example, a new listing for the property, a return of the property to the market after being removed from the market, or a price change. Collapse grid column 834 permits the user to select a subject property (by actuating an icon in column 834 associated with the subject property) as the sole property to be displayed in grid 702. After collapsing results grid 702 in this manner, the user may regenerate the original display of all subject properties by actuating regeneration icon 835. Finally, favorites column 836 permits the user to mark properties to be saved to the user's profile so the user can track and easily revisit favorite properties of interest.

Referring now to FIG. 9, comp listing 704 generally provides information relating to properties which are comparable to the property highlighted by the user in results grid 702 (in the case of FIGS. 8A and 8B, the second listed property having MLS# 5015424). More specifically, comp listing 704 includes a comp status bar 902, a view icon column 904, an MLS# column 906, an address column 908, a price column 910, a normalized price column 912, a price/square foot column 914, a square footage column 916, a DOM column 918, a COE (close of escrow) column 920, a select column 922 and a scroll bar 924.

Comp status bar 902 permits the user to select the type of comparable property to be displayed in comp listing 704. In this example, for the selected subject property, 31 comparable properties have been identified, including 19 closed properties, 9 active properties, and 3 pending properties. As shown in FIG. 9, “All” comparable properties has been selected, but the user may instead actuate one of the other types to display only comparable properties that have closed, are active, or are pending. View icon column 904 includes an icon 926 if the corresponding comparable property has a property view file associated with it as described further below with reference to FIG. 10. As was the case for corresponding columns in results grid 702 (FIGS. 8A and 8B), MLS# column 906, address column 908, price column 910, price/square foot column 914, square footage column 916, and DOM column 918 indicate for the listed comparable property the MLS listing number, address, list price, list price divided by square footage, square footage and date of manufacture, respectively, for the displayed comparable properties. Normalized column 912 provides a normalized price computed by analysis system 102 for the comparable property in the manner described below. COE column 920 indicates the close of escrow date, and is only displayed for closed comparable properties. Finally, select column 922 permits the user to select/deselect comparable properties (by actuating a corresponding check box) to be used in the computation of Uvalue as is described in further detail below.

When a user actuates an icon 926 in view icon column 904, analysis system 102 generates a property detail screen such as property detail screen 1000 as shown in FIG. 10. Property detail screen 1000 includes an address bar 1002, which displays the address of the comparable property corresponding to the actuated icon 926, a property information tab 1004, a map tab 1006, and a price indicator 1010, which displays the list price of the comparable property. When property information tab 1004 is selected (as shown in FIG. 10), property detail screen 1000 further includes an image display area 1012, a property data area 1014, a property description area 1016, and a property details area 1018. When map tab 1006 is actuated (not shown), screen 1000 provides a map view having the selected comparable property centered in the map.

In one embodiment of the disclosure, image display area 1012 provides a slide show of photographic images of the comparable property. In other embodiments, other audio/visual content is provided, such as a narrated video of the comparable property. Property data area 1014 provides a summary listing of information about the property, including much of the same information displayed in comp listing 704 (i.e., address, MLS#, DOM, square footage, price/square foot, etc.). Property description area 1016 provides a textual narrative description of the property of the type commonly provided for real estate listings. Finally, property details area 1018 provides additional, even more specific detailed information about the property and surrounding area, including pricing history, property tax and home owner's association information, and school information.

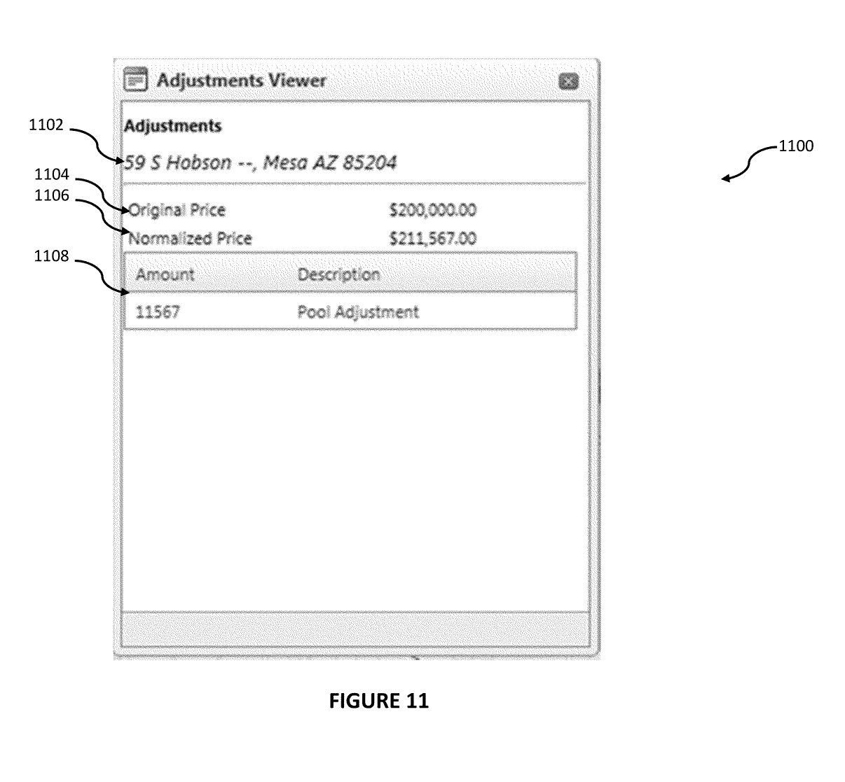

Referring now to FIG. 11, when a user actuates a normalized price of a comparable property (column 912 of FIG. 9), a window such as that depicted in FIG. 11 pops up to provide information regarding adjustments made by analysis system 102 to the sales price (i.e., closed or sold price) of the property. Adjustments viewer screen 1100 provides the address 1102 of the selected comparable property, the original price 1104, the normalized price 1106 and a listing 1108 of adjustments to the normalized price. In the example depicted in FIG. 11, analysis system 102 determined from the MLS data associated with the property that it includes a pool. For the particular area in which the property is located and based on configuration data described below, analysis system 102 determined that a pool required an increase from the original price by $11,567 to normalize the price of the property. As is described below, the normalized price for a comparable property listed in column 912 of FIG. 9 is used to compute the Rvalue for a selected subject property.

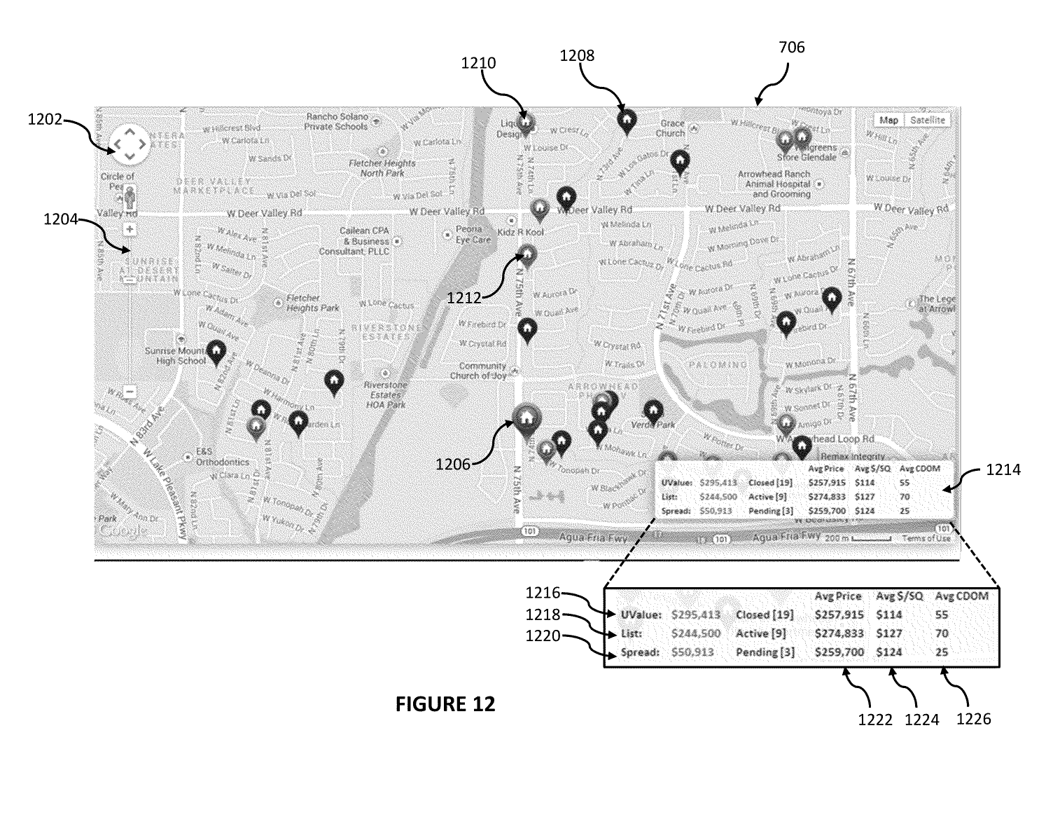

Map display 706 of the comp viewer area is depicted in FIG. 12. As shown, map display 706 provides a standard map view of a plurality of properties denoted by various icons as is further described below. Map display 706 includes a conventional navigation button 1202 and a conventional zoom control 1204. Map display 706 further includes a subject property icon 1206, and a plurality of comparable property icons, including closed icons 1208, active icons 1210 and pending icons 1212. Finally, map display also includes a comp analysis box 1214.

The subject property icon 1206 of map display 706 indicates the map location of the property highlighted by the user in results grid 702 (again, in the case of FIGS. 8A and 8B, the second listed property having MLS# 5015424). Closed icons 1208 indicate the map locations of comparable properties listed in comp listing 704 (FIG. 9) that have been sold. Active icons 1210 indicate the map locations of comparable properties listed in comp listing 704 (FIG. 9) that are currently available for purchase (or rent, depending upon the search criteria selected). Pending icons 1212 indicate the map locations of comparable properties listed in comp listing 704 (FIG. 9) that are currently under contract (i.e., in the process of being sold), but have not yet closed. Subject property icon 1206, closed icons 1208, active icons 1210, and pending icons 1212 may each be displayed using a color or other indicia that is different from the colors or indicia used to display the other icons.

Comp analysis box 1214 includes Uvalue field 1216, a list price field 1218, a spread field 1220, and for each category of comparable property listed in comp listing 704 (FIG. 9) (i.e., closed, active and pending), an average price 1222, an average price/square foot 1224, and an average CDOM (cumulative days on the market) 1226. In this example, the average sales (i.e., closed or sold) price 1222 of the 19 comparable properties listed in comp listing 704 is $257,915, the average price/square foot 1224 is $114, and the average CDOM 1226 if 55 days.

Uvalue field 1216 provides the average normalized price of the comparable properties shown in comp listing 704 that are automatically selected or that a user has selected by checking boxes in select column 922. When comp listing 704 is initially displayed, a number of top comparable properties are pre-selected (i.e., the corresponding boxes in select column 922 are checked) based on configuration information described below. Thus, initially Uvalue field 1216 provides the average normalized price (i.e., sales price adjusted in the manner described above based on factors such as a pool) of all of the pre-selected comparable properties. The user may, however, select fewer, more or different comparable properties from comp listing 704 and analysis system 102 automatically adjusts Uvalue field 1216 to display the average normalized price of the user's selection. List price field 1218 provides the list price (column 816 of FIG. 8A) of the highlighted or active subject property so the user can easily compare the price of the subject property to the average, normalized price of the selected comparable properties. Finally, spread field 1220 shows the difference between the values displayed in Uvalue field 1216 and list price field 1218.

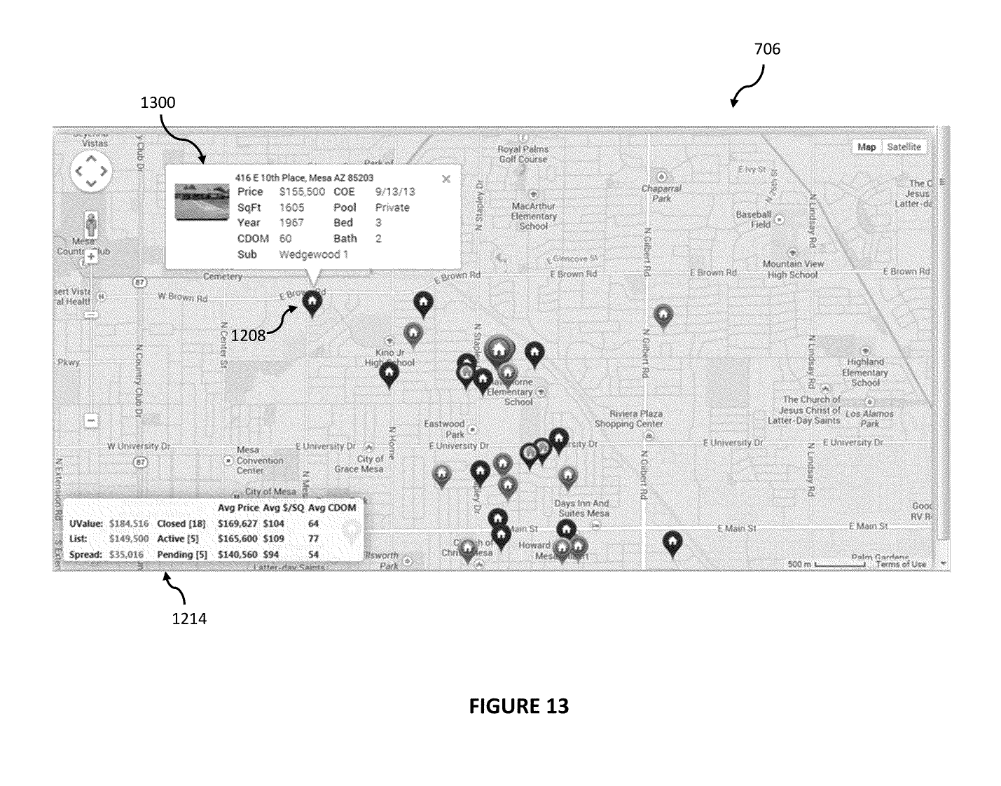

When a user actuates subject property icon 1206 or one of closed icons 1208, active icons 1210, or pending icons 1212 on map display 706, analysis system 102 generates and displays a pop-up property summary box such as box 1300 depicted in FIG. 13. Summary box 1300 provides basic information about the property corresponding to the selected icon (i.e., address, price, square footage, year built, DOM, etc.). In one embodiment of the disclosure, the user may actuate the address information (displayed as a hot link) which causes analysis system 102 to generate and display a full property detail screen such as screen 1000 described above with reference to FIG. 10.

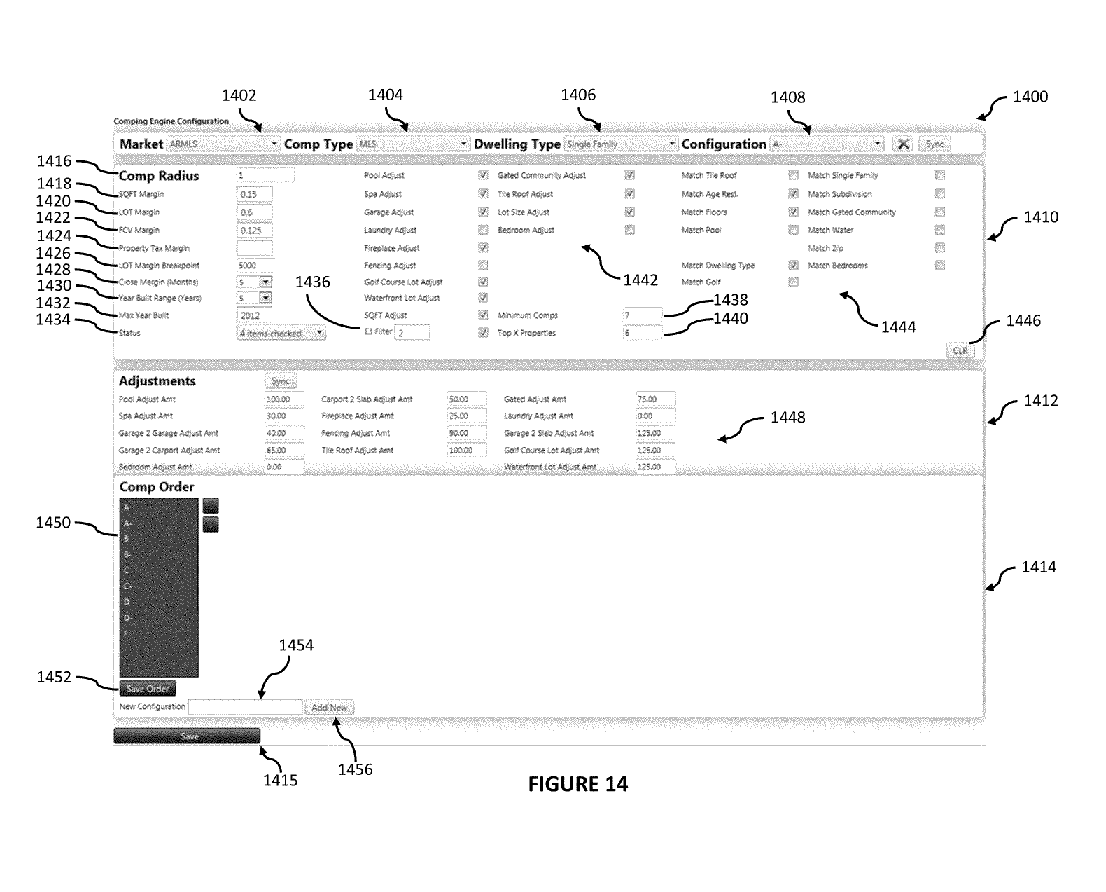

Much of the content provided to the user via the various screens discussed above is a function of configuration information used by analysis system 102 and stored in memory 206 of computing device 202. As is customary in the art, only certain individuals (e.g., administrators) have access to this configuration data. If such an individual (hereinafter, “administrator”) logs into analysis system 102, the administrator can select a configuration set up screen such as configuration screen 1400 depicted in FIG. 14. Configuration screen 1400, in one embodiment of the disclosure, initially only displays a market drop-down 1402, a comp type drop-down 1404, a dwelling type drop-down 1406 and a configuration drop-down 1408. The remainder of the content of configuration screen 1400 is only displayed after selections are made from these drop-downs. Market drop-down 1404 allows the administrator to select a particular geographic real estate market to configure. Comp type drop-down 1404 allows the administrator to select from either MLS comparable properties or rental properties to configure. Dwelling type drop-down 1406 permits the administrator to select from a plurality of different dwelling types to configure, such as, for example, single family dwellings, duplexes, townhomes, condos, etc. Finally, configuration drop-down 1408 allows the administrator to select a grade to configure as is further described below. As indicated above, when a user defines a saved search using screen 500 of FIG. 5, the user selects from min. grade drop-down 518 the minimum grade to be associated with properties returned by the search. In one embodiment of the disclosure, grades A through F are used. Each grade functions essentially as a filter for the comparable properties to be associated with any particular subject property. Comparable properties that satisfy the grade A filter have high correlation to the subject property, while comparable properties that only satisfy a grade F filter have low correlation. Each of these grade filters can be configured in the manner described below for any combination selected from drop-downs 1402, 1404, and 1406.

In the example depicted in FIG. 14, the selected market is Arizona, the selected comp type is MLS listings, the selected dwelling type is single family dwellings, and the selected configuration is A−. With the above-described selections made, configuration screen 1400 further includes a parameters area 1410, an adjustments area 1412, a comp order area 1414, and a save button 1415. Parameters area 1410 includes a comp radius field 1416, a square footage margin field 1418, a lot margin filed 1420, an FCV field 1422, a property tax margin field 1424, a lot margin breakpoint filed 1426, a close margin drop-down 1428, a year built range drop-down 1430, a maximum year built field 1432, a status drop-down 1434, a sigma filter field 1436, a minimum comps field 1438, a top X properties filed 1440, a plurality of adjustment options 1442, a plurality of match options 1444, and a clear button 1446. Comp radius field 1416 permits the administrator to specify a radius in miles from a subject property within which to locate comparable properties. It should be understood, however, that instead of a radius, field 1416 may specify a number of square miles centered on the subject property within which to locate comparable properties. Comparable properties outside this specified radius will not be associated with the subject property. Square footage margin field 1418 permits the administrator to specify a percentage deviation in terms of square footage a comparable property may have from a minimum and/or maximum square footage entered in fields 534 of search screen 500, yet still be considered comparable at the specified grade level. Similarly, lot margin field 1420 permits the administrator to specify a percentage deviation in terms of lot square footage a comparable property may have from a minimum and/or maximum lot square footage entered in fields 530 of search screen 500, yet still be considered comparable at the specified grade level. FCV margin field 1422 permits the administrator to specify a percentage deviation in terms of full cash value (or tax assessor value) a comparable property may have from the FCV of the subject property, yet still be considered comparable at the specified grade level. Similarly, property tax margin field 1424 permits the administrator to specify a percentage deviation in terms of a weighted property tax value the comparable properties may have from the subject property yet still be considered comparable at the specified grade level. In one embodiment, the weighted property tax value is computed by adding 90% time the interior square footage of the property to 10% of the square footage of the lot. Lot margin breakpoint field 1428 permits the administrator to specify the lot margin breakpoint. The lot margin breakpoint limits the comparable properties returned from a search based on the lot size of the subject property. More specifically, if the subject property has a lot size that is above the lot margin breakpoint, only comparable properties with lot sizes above the breakpoint will be returned from the search. Similarly, if the subject property has a lot size below the breakpoint, the search will return only comparable properties with lot sizes below the breakpoint. Close margin drop-down 1428 permits the administrator to select the number of months the configuration will use to find comparable properties that have closed escrow. For example, if the month number is set to five, a search will only return comparable properties that closed escrow within the past five months. Year built range drop-down 1430 permits the administrator to specify deviation in terms of number of years a comparable property may have from the year built associated with a subject property, yet still be considered comparable at the specified grade level. Maximum year built field 1432 permits the administrator to specify the upper limit in terms of year built a comparable property may have to be returned with a search. This field permits the administrator to, for example, ensure that newly constructed properties will not be returned with a search as comparable properties. Status drop-down 1434 permits the administrator to select one or more status types (e.g., active, pending, closed, etc.). Only properties having a selected status will be returned with a search a displayed on map display 706.

Sigma filter field 1436 allows the administrator to specify the number of standard deviations away from an average price/square footage of the configuration's closed data set. Properties having price/square footage values that deviate more than the specified number of standard deviations are essentially considered outliers, and excluded from the Rvalue calculation if they would have been included as one of the top X properties (described below).

Minimum comps field 1438 permits the administrator to specify the minimum number of comparable properties that must be returned with the search results for a particular subject property for the particular grade being configured. For example, if minimum comps field is set to seven, and only five grade A− comparable properties satisfy the parameters specified in parameters area 1410, then analysis system 102 may apply the grade B configuration and determine whether at least seven comparable properties satisfy that configuration. If so, then those comparable properties are displayed in comp listing 704. If not, then analysis system 102 may apply the grade B− configuration, and so on. In one embodiment of the disclosure, an array of grade configurations from A to F may be populated using the above-described fields as follows:

| | A | A- | B | B- | C | C- | D | D- | F |
|---|---|---|---|---|---|---|---|---|---|
| Radius | 1 | 1 | 1.15 | 1.25 | 1.25 | 1.5 | 1.5 | 2 | 3 |
| Sq. ft. | 0.125 | 0.15 | 0.175 | 0.175 | 0.2 | 0.2 | 0.25 | 0.25 | 0.3 |
| Margin | | | | | | | | | |
| Lot | 0.6 | 0.6 | 0.75 | 0.75 | 1 | 1 | 1 | 1 | |
| Margin | | | | | | | | | |
| FCV | 0.125 | 0.125 | 0.15 | 0.175 | 0.2 | 0.25 | 0.35 | 0.5 | |
| Margin | | | | | | | | | |
| Tax | | | | | | | | | |
| Margin | | | | | | | | | |
| Close | 4 | 5 | 6 | 6 | 9 | 9 | 12 | 12 | 12 |
| Margin | | | | | | | | | |
| Year Built | 5 | 5 | 7 | 7 | 9 | 9 | 9 | 9 | 12 |
| Min. | 7 | 7 | 7 | 7 | 6 | 6 | 4 | 4 | 3 |
| Comps | | | | | | | | | |
| Top X | 6 | 6 | 6 | 6 | 5 | 5 | 3 | 3 | 3 |
| Props | | | | | | | | | |

Top X properties field 1440 permits the administrator to specify the number of the most closely matched comparable properties associated with a subject property to use in the initial computation of Uvalue as described above with reference to Uvalue field 1216 of FIG. 12. The number specified determines the number of boxes automatically selected in column 922 (FIG. 9) of comp listing 704. The normalized prices of these properties are averaged to provide the Rvalue. While initially the Uvalue and Rvalue are the same, the user may select other comparable properties (i.e., other than those initially returned as the top X properties) by checking different boxes in column 922 of comp listing 704. The normalized prices of those selected properties are then averaged to provide the computed Uvalue in Uvalue field 1216 of FIG. 12. It should be understood that in one embodiment of the disclosure, the top X properties “carry over” from one grade configuration to the next. For example, if two comparable properties were found that satisfy the grade A configuration for a subject property, three properties were found that satisfy the grade A− configuration, and four properties were found that satisfy the grade B configuration, then the top X properties initially selected (and used to compute the subject property's Rvalue) will include the two grade A comparables, the three grade A− comparables, and the grade B comparable property that has the highest normalized price.

Adjustment options 1442 provide a variety of different property features the administrator may specify as being used to normalize the price of a comparable property if the comparable property has the selected feature(s). In the example depicted in FIG. 14, by checking the boxes associated with the property features, the administrator has selected a pool adjustment, spa adjustment, garage adjustment, fireplace adjustment, golf course lot adjustment, waterfront lot adjustment, square footage adjustment, gated community adjustment, tile roof adjustment, and lot size adjustment. Any comparable properties having one or more of these features will have a normalized price listed in column 912 (FIG. 9) of comp listing 704 that is adjusted to account for the value of the features. Depending upon the adjustment options 1442 the administrator selects, adjustments area 1412 is populated with corresponding option value fields 1448 as shown in FIG. 14. These fields 1448 permit the administrator to specify a multiplier of the price/square foot value associated with the comparable property to be added as a result of the property having the selected feature(s). For example, as shown in adjustments area 1412, the administrator has entered 125.00 into the waterfront lot adjust field. Consequently, for any comparable property returned from a search having a waterfront lot, analysis system 102 will increase the sales (i.e., sold or closed) price by an amount equal to $125 times the price per square foot for the property when computing the normalized price for the property. The values entered for the various fields 1448 may be chosen at least in part based on knowledge and experience with the selling prices of properties in a particular market.

Match options 1444 permits the administrator to specify “must match” features for comparable properties as they relate to a subject property. For example, in the example depicted in FIG. 14, the match floors match option 1444 is selected. Accordingly, for a subject property having one floor, only comparable properties also having one floor will be returned with the search. Clear button 1446 permits the administrator to clear all fields of parameters area 1410.

Finally, comp order area 1414 includes a comp order listing 1450, a save order button 1452, a new configuration field 1454, and an add new button 1456. Comp order listing 1450 permits the administrator to specify the order in which the various grade configurations (described above) are applied in determining comparable properties. After the comp order has been specified, the administrator may actuate save order button 1452 to ensure that the specified order will be applied when the configuration data of configuration screen 1400 is applied. New configuration field 1454 permits the administrator to name a new configuration to be saved. In comp order listing 1450 of FIG. 14, nine configurations are shown (A-F). The administrator could, for example, add a new B+ configuration by entering its name in new configuration field and actuating add new button 1456. Then, the administrator could select the B+ configuration using configuration drop-down 1408 and define the configuration in the manner described above. When the administrator actuates save button 1415, the new configuration is saved and will be displayed in comp order listing 1450.

As should be understood from the foregoing, an administrator may configure various different grade “filters” associated with a particular market, comp type and dwelling type combination. These grade filters are then used to identify top comparable properties and compute their normalized prices in the manner described above. Additionally, the result also permits analysis system 102 to compute an Rvalue for each subject property that satisfies a particular search criteria. The Rvalue (displayed in column 824 of results grid 702 of FIG. 8B) provides an indication of the after repair value of a subject property, which is a value estimate of particular interest to real estate investors and/or real estate agents.

In operation, a user logs into analysis system 102 in the manner described above. The user then defines or selects a search criteria by interacting with search screen 500 as described above. Analysis system 102 then returns properties that satisfy the search criteria in results grid 702 of results screen 700. Each of these properties has an associated Rvalue as shown in column 824 of results grid 702 (FIG. 8B). The Rvalues are derived from the comparable properties associated with the subject property. For each displayed subject property, analysis system 102 applies configuration data associated with the market, comp type and dwelling type to identify properties that are comparable to the selected property in the manner described above. These properties are displayed in comp listing 704 and map display 706 when the user selects a particular subject property. The top X comparable properties (as specified in top X properties field 1440 of configuration screen 1400) are identified by analysis system 102 and displayed with their corresponding check boxes (column 922 of comp listing 704) automatically checked. The normalized prices of these comparable properties (and the other comparable properties listed in comp listing 704) are determined based on the adjustment criteria specified in configuration screen 1400. Analysis system 102 averages the normalized prices of the top X comparable properties to compute the Rvalue for the selected subject property. The Rvalue is thus the same as the initial Uvalue displayed in comp analysis box 1214 (FIG. 12), which is also the average of the normalized prices of the initial, automatically selected comparable properties displayed in comp listing 704. The user may investigate the various displayed comparable properties by, for example, actuating their associated icon 926 in view icon column 904, decide that other comparable properties are more relevant to the value of the selected subject property, and select those comparable properties to get a different Uvalue, which may be a more reliable indicator of the remodeled or after-repair value of the subject property than the initially computed Rvalue.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method for evaluating properties, comprising:
receiving, using a computing device, data describing a plurality of characteristics for each of a plurality of properties;
identifying, using the computing device, subject properties by applying search criteria to the data, the subject properties satisfying the search criteria;
for a selected subject property, identifying, using the computing device, comparable properties by applying configuration criteria to the data, the comparable properties satisfying the configuration criteria; and
determining, using the computing device, an Rvalue of the selected subject property by averaging normalized prices of a plurality of comparable properties, the Rvalue indicating an after-repair value of the selected subject property.

2. The method of claim 1, wherein receiving includes receiving MLS data from an MLS system over a network.

3. The method of claim 1, further including receiving the search criteria from a user system connected to the computing device over a network.

4. The method of claim 3, wherein the search criteria permit a user to specify geographic, physical and financial parameters required for a subject property to be identified from the plurality of properties.

5. The method of claim 1, wherein identifying comparable properties includes applying a plurality of configuration criteria to the data, application of a first of the plurality of configuration criteria resulting in identification of comparable properties having a first degree of relevance to the selected subject property, and application of a second of the plurality of configuration criteria resulting in identification of comparable properties having a second degree of relevance to the selected subject property, the first degree of relevance being greater than the second degree of relevance.

6. The method of claim 5, wherein each of the plurality of configuration criteria specify geographic, physical and financial parameters required for a comparable property to be identified as a comparable property having a degree of relevance to the selected subject property associated with the configuration criteria.

7. The method of claim 1, wherein the normalized prices of the plurality of comparable properties include adjustments from sales prices based on features of the plurality of comparable properties as specified in the configuration criteria.

8. The method of claim 1, wherein the configuration criteria specifies a number of comparable properties to be used in determining the Rvalue.

9. The method of claim 1, further including determining, using the computing device, a Uvalue by averaging the normalized prices of the plurality of comparable properties.

10. The method of claim 9, further including enabling a user to select comparable properties satisfying the configuration criteria other than the plurality of comparable properties, and determining a new Uvalue by averaging normalized prices of the selected comparable properties.

11. A non-transitory computer-readable media including instructions that, when executed by a processor, cause the processor to
access data stored in a database associated with the processor, the data describing a plurality of characteristics for each of a plurality of properties;
identify subject properties by applying search criteria to the data, the subject properties satisfying the search criteria;
for a subject property selected by a user with an input device, identify comparable properties by applying configuration criteria to the data, the comparable properties satisfying the configuration criteria; and
determine an Rvalue of the selected subject property by averaging normalized prices of a plurality of comparable properties, the Rvalue indicating an after-repair value of the selected subject property.

12. The non-transitory computer-readable media of claim 11, wherein the instructions, when executed by the processor, further cause the processor to receive the search criteria from a user system connected to the processor over a network.

13. The non-transitory computer-readable media of claim 12, wherein the search criteria permit a user to specify geographic, physical and financial parameters required for a subject property to be identified from the plurality of properties.

14. The non-transitory computer-readable media of claim 11, wherein the instructions, when executed by the processor, further cause the processor to identify comparable properties by applying a plurality of configuration criteria to the data, application of a first of the plurality of configuration criteria resulting in identification of comparable properties having a first degree of relevance to the selected subject property, and application of a second of the plurality of configuration criteria resulting in identification of comparable properties having a second degree of relevance to the selected subject property, the first degree of relevance being greater than the second degree of relevance.

15. The non-transitory computer-readable media of claim 14, wherein each of the plurality of configuration criteria specify geographic, physical and financial parameters required for a comparable property to be identified as a comparable property having a degree of relevance to the selected subject property associated with the configuration criteria.

16. The non-transitory computer-readable media of claim 11, wherein the normalized prices of the plurality of comparable properties include adjustments from sales prices based on features of the plurality of comparable properties as specified in the configuration criteria.

17. The non-transitory computer-readable media of claim 11, wherein the configuration criteria specifies a number of comparable properties to be used in determining the Rvalue.

18. The non-transitory computer-readable media of claim 11, wherein the instructions, when executed by the processor, further cause the processor to determine a Uvalue by averaging the normalized prices of the plurality of comparable properties.

19. The non-transitory computer-readable media of claim 18, wherein the instructions, when executed by the processor, further cause the processor to enable a user to select comparable properties satisfying the configuration criteria other than the plurality of comparable properties, and determine a new Uvalue by averaging normalized prices of the selected comparable properties.

20. A system for evaluating properties, comprising:
a network interface configured to couple to a first computing device and a second computing device over a network;
a computing device having a processor and a memory including instructions for execution by the processor; and
a database;
wherein the instructions, when executed by the processor, cause the processor to
receive data describing a plurality of properties from the first computing device over the network;
store the received data in the database;
identify subject properties by applying search criteria to the received data, the subject properties satisfying the search criteria;
receive a selection of a subject property from the second computing device over the network;
for the selected subject property, identify comparable properties by applying configuration criteria to the received data, the comparable properties satisfying the configuration criteria; and
determine an Rvalue of the selected subject property by averaging normalized prices of a plurality of comparable properties, the Rvalue indicating an after-repair value of the selected subject property.
